(19) United States
(12) Patent Application Publication
(10) Pub. No.: US 2025/0208005 A1
(43) Pub. Date: Jun. 26, 2025

(54) METHOD, SYSTEM, AND APPARATUS FOR TESTING PROPORTIONING ACCURACY OF NON-METERED PROPORTIONING SYSTEMS

(71) Applicant: Big Dog Flow Testing, LLC., Little Egg Harbor, NJ (US)

(72) Inventor: Stephen W. HAINES, Little Egg Harbor, NJ (US)

(73) Assignee: Big Dog Flow Testing, LLC., Little Egg Harbor, NJ (US)

(21) Appl. No.: 18/987,349

(22) Filed: Dec. 19, 2024

Related U.S. Application Data
(60) Provisional application No. 63/613,385, filed on Dec. 21, 2023.

(51) Int. Cl. G01M 99/00; A62C 37/50

(52) U.S. Cl. CPC G01M 99/008; A62C 37/50

(57) ABSTRACT

A method, system, and apparatus for testing non-metered proportioning systems used for fire protection and other critical applications. Exemplary embodiments described herein can allow proportioning accuracy tests to be completed at the time of acceptance, annually thereafter, and following any repairs with no discharge of concentrate or chemicals to the environment. Further exemplary embodiments allow Newtonian liquids to be utilized as surrogates for non-Newtonian concentrates. Additionally, the methods, systems and apparatus can be configured to permit the proportioning system to be safely actuated manually, remotely, or automatically with no concentrate or chemical discharge to prove the function and operation of all moving, electrical powered, engine driven, and hydraulic powered parts and components during the proportioning accuracy test.

### BACKGROUND

The non-metered proportioning systems used for fire protection and other critical applications need to be tested periodically to confirm that proportioning ratios are within original accuracy specifications and operate as intended. The testing of non-metered foam proportioning systems on mobile fire apparatus and in fixed or semi-fixed fire suppression systems, is required at the time of acceptance, at least annually thereafter, and following any repairs that may affect system performance by local, municipal, state and/or federal law, as well as by insurers.

Accordingly, the National Fire Protection Association and other organizations have developed standards and guidelines addressing these requirements. Over the last five to ten years, the practice of discharging foam solutions to the environment, as called for in these standards and guidelines, has become frowned upon and is likely to be become illegal throughout the USA in the near future due to environmental concerns (already illegal in some states).

Foam concentrates are chemicals. While the foam fire suppression industry is migrating away from formulations that include fluorinated hydrocarbons, a recognized environmental concern; lingering concerns remain with many users that these new formulations may include chemicals that will be recognized as a health or environmental hazard at a later date.

Older and less environmentally safe foams will likely remain in use for decades. As such, foam testing methods, systems, and apparatus must be configured to eliminate or minimize contact with portable test equipment, hose, hand tools, etc. in order to prevent contamination of other systems using newer and more environmentally friendlier foam concentrates.

Foam concentrate waste and contaminated materials may be difficult or expensive to dispose of. As such, the intentional, incidental, and accidental use or loss of concentrate, and subsequent cleanup must be minimized during proportioning accuracy testing.

The health effects of older and even newer foam concentrates on testing personnel are not completely understood. As such, the potential for personnel contacting foam concentrate or chemicals must be minimized during proportioning accuracy testing.

Many of the new, synthetic fluorine free firefighting foam concentrates are non-Newtonian liquids. The viscosity of these liquids, unlike Newtonian liquids such as water, is not constant and varies significantly with changes in liquid flow rates and other conditions. As such, proportioning accuracy testing must address the hydraulic characteristics of non-Newtonian liquids as well as Newtonian liquids.

Many of the requirements and concerns discussed above, apply to non-metered proportioning systems that are utilized to accurately and cost effectively mix materials in other applications and industries including, but not limited to agriculture, farming, insect pest control, aircraft deicing, etc.

As a result, improved testing methods, systems and apparatus are needed for testing of foam proportioning systems onboard fire apparatus and in fixed or semi-fixed fire suppression systems and of chemical proportioning or mixing systems in other industries.

### SUMMARY

A method, system, and apparatus for testing proportioning accuracy of non-metered proportioning systems at the time of acceptance, at least annually thereafter, and following any repairs that may affect system performance. Exemplary embodiments described herein can eliminate the discharge of foam concentrate or other chemicals to the ground or other ambient environments during proportioning accuracy testing. Thus, protecting the environment and test personnel from intentional, incidental, and accidental exposure to these chemicals and potential harmful effects.

Exemplary embodiments may include pre-test calculations to identify necessary pressure and flow relationships within the concentrate or chemical supply network and the inclusion of one or more pressure taps and a transition piece in the permanent piping of the proportioning systems between the proportioning device and the concentrate supply. During a proportioning accuracy test the transition piece may be removed at which time the upstream pipe from the foam concentrate or chemical supply is capped, and a hose is attached to the downstream pipe leading to the proportioning device. The hose may then be connected to a source of an environmentally safe surrogate and pressure measurement devices are connected to the pressure taps. Flow measurements devices may be provided on the surrogate supply hose and either downstream or upstream of the proportioning device.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate

FIG. 1 is an exemplary view of elements of a non-metered proportioning system in non-testing mode where the concentrate is supplied from a fixed tank as its contents are displaced by the primary liquid source. The tank may or may not include a means, such as a bladder, of keeping the liquids in the tank separated.

FIG. 2 is an exemplary view of the non-metered proportioning system shown in FIG. 1 configured in testing mode.

FIG. 3 is an exemplary view of elements of a non-metered proportioning system in non-testing mode where the concentrate is supplied from an atmospheric or pressurized source. Pressurized sources are typically regulated to maintain the same pressure as that measured at or upstream of the primary liquid inlet of the proportioning device.

FIG. 4 is an exemplary view of the non-metered proportioning system shown in FIG. 3 configured in testing mode.

FIG. 5 is an exemplary view showing an alternative transition piece location for multiple outlet, non-metered foam proportioning systems.

FIG. 6 is an exemplary method for conducting proportioning accuracy testing.

FIG. 7 is an exemplary method for confirming operation and flow capacity of a pressurized concentrate source.

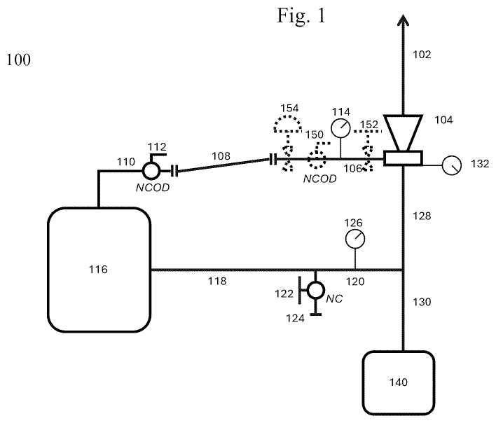

FIGS. 1 through 5 do not necessarily show or list all components of typical proportioning systems other than those needed to describe the exemplary method, system, and apparatus for testing proportioning accuracy of non-metered proportioning systems. Furthermore, the relative placement of proportioning system components to each other and to those of the exemplary method, system, and apparatus for testing proportioning accuracy of non-metered proportioning systems may vary.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

Further, some of the embodiments described herein may be described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, a computer configured to perform the described action.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

As used herein, the term “concentrate” is any Newtonian or non-Newtonian foam concentrate, liquid, or chemical that is accurately mixed in small to moderate proportions into a flowing stream of a primary liquid.

As used here-in the term “primary liquid” refers to the water or liquid upstream of the point at which the concentrate is to be injected in specific proportions. The most common primary liquid for fire protection purposes is water, including seawater.

As used here-in the term “solution” refers to the mixture of a concentrate and a primary liquid that is intended to be at a ratio within prescribed limits of accuracy for use in the application. The ratio of concentrate to primary liquid in the solution may be set permanently or may be adjustable depending upon the configuration of a proportioning system.

As used here-in the term “non-metered proportioning system” or “proportioning system” includes all proportioning systems that do not measure the primary liquid flow rate or the solution flow rate to determine and regulate the concentrate injection rate. This is often achieved by managing the absolute pressure across an orifice that is located at or in close proximity to the point of concentrate injection into the primary liquid or by using the velocity pressure of the primary liquid stream to mechanically manipulate the rate of concentrate injection into the primary liquid. The point of injection in these systems is typically part of what is referred to here-in as a “proportioning device”.

Additionally, as used herein the terms “metered proportioning system” includes all proportioning systems that measure the primary liquid flow rate or the solution flow rate to determine the correct concentrate injection rate and then injects the concentrate into the liquid at the correct rate by controlling the average or mean flow rate of the chemical as the point of injection. The flow of the concentrate into the point of injection may be continuous or pulsed.

Additionally, as used herein the terms “system”, “testing system”, and “proportioning accuracy test system” may be inferred to mean a system or apparatus to test the accuracy of a proportioning system.

Additionally, as used herein, the term “surrogate” is any liquid used as a substitute for concentrate during the proportioning accuracy testing that is non or minimally harmful to the environment, persons and/or downstream storage or processes. The most commonly available surrogate for fire protection purposes is water, including seawater.

Additionally as used herein, the term “discharge solution outlet” encompasses all piping, discharge devices, test connections or ports, components, and other appurtenances that convey solution from the proportioning device to one or more points of discharge during normal use or testing of the proportioning system.

Additionally, as used herein, the terms “flow measurement device” “flow meter” or “flow meter assemblies” can mean any instrument, device, or assembly thereof used to monitor, measure, or record the rate of flow a liquid or volume of liquid flowed over time. Further, a flow measurement device may or may not require an external power source. The flow measurement device may be powered by water flowing through the system, or an internal power source, such as a battery.

Additionally, as used herein, the term “pressure measurement device” can mean any instrument, device, or assembly thereof used to monitor, measure, or record the pressure of a liquid or when used in multiples to monitor, measure, or record the differential pressure between two points in a liquid filled system. Pressure measurement devices are installed into fittings herein referred to as “pressure taps” 114, 126, & 314.

According to an exemplary embodiment, and referring generally to FIGS. 1-7, various exemplary embodiments of a method, system, and apparatus for testing the proportioning accuracy of non-metered proportioning systems may be shown and described.

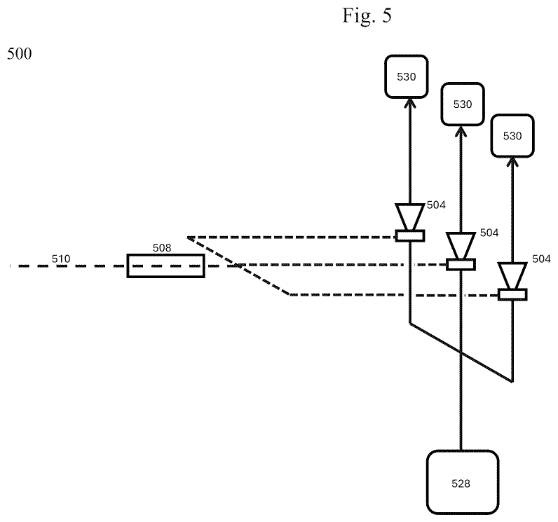

In still further embodiments, and referring generally to FIGS. 1-5 any or part, item, or source depicted in system 100, system 200, system 300, or system 400 or in FIG. 5 or the systems in their entireties may be portable, mobile (mounted on board a vehicle), temporary, ad hoc, expendable or consumable, semi-permanently installed, or permanently installed.

Referring to the exemplary embodiment in FIG. 1, FIG. 1 may illustrate a proportioning system 100 that is in non-testing mode. The testing system 100 may include a variety of components. The components may be, but are not limited to, a transition piece 108, pressure taps 114, 126 & 132, a primary liquid hose valve assembly 122 & 124 and a variety of valves and devices common to proportioning systems. It may be understood that according to an embodiment the primary liquid hose valve assembly may be normally closed. Multiple valves, hoses, flow meters, and pressure gauges may be integrated into the system, depending on the application.

It may be understood that according to an embodiment the proportioning system 100 may include a proportioning device 104 which may incorporate a primary liquid from a pressurized source 140 and a concentrate from a displacement type concentrate tank or supply 116 in order to generate a solution. The solution may be understood to require a specific ratio or range of ratios according to the proportioning system specifications. The output of the proportioning device 104 may then connect to a solution discharge outlet 102 which may discharge the solution.

It may be contemplated that configurations other than the configuration depicted in FIG. 1 may be utilized, as desired. In such an exemplary embodiment, however, the placement of pressure taps 114, 126 & 132 and the primary liquid hose connection assembly comprised of hose connection control valve 122 and hose connection 124 may be relocated based upon accessibility, overall configuration of the proportioning system's plumbing, to enhance analysis accuracy, and/or for other purposes.

In still further exemplary embodiments, a secondary control valve 150 may be installed to prevent water intrusion into the transition piece 108 if proportioning device 104 remains full and/or pressurized with primary fluid when the system is in non-testing mode. It may be understood that according to an embodiment the secondary control valve may be normally open or normally closed but opened on demand. Further, the operation of the secondary control valve 150 may be the same as the concentrate control valve 112 and may be addressed in the operating logic or instructions of the proportioning system. It may be understood that according to an embodiment the control valve may be normally closed but opened on demand. Additionally, a drain and/or vent valve may be provided on the transition piece 108 to allow it to be depressurized and drained in the event of leakage at the concentrate control valve 112 or the secondary control valve 150.

In still further exemplary embodiments, the outlet of the transition piece 108 may be at a higher elevation than its inlet, which may be understood to minimize the potential of concentrate residues or seepage at the concentrate control valve 112 entering and contaminating any system components downstream of the transition piece 108. Alternatively, the transition piece 108 may incorporate a sump, well, widening, contour, or other variation in shape or configuration to create an area into which concentrate residues or seepage at the concentrate control valve 112 may collect or a raised area to prevent concentrate residues or seepage at the concentrate control valve 112 from traveling across the transition piece 108. Alternatively, the transition piece 108 may be replaced by a permanently piped valve configuration or other means to provide an air gap between the foam concentrate source and the proportioning device and prevent contamination of the surrogate liquid by the concentrate or concentrate residue when the system is in testing mode in lieu of the removable transition piece 108.

In still further exemplary embodiments, transition piece 108 may be located as close to the concentrate control valve 112 as practical to minimize cleanup and decontamination in the event of concentrate residue transition or seepage at the concentrate control valve 112.

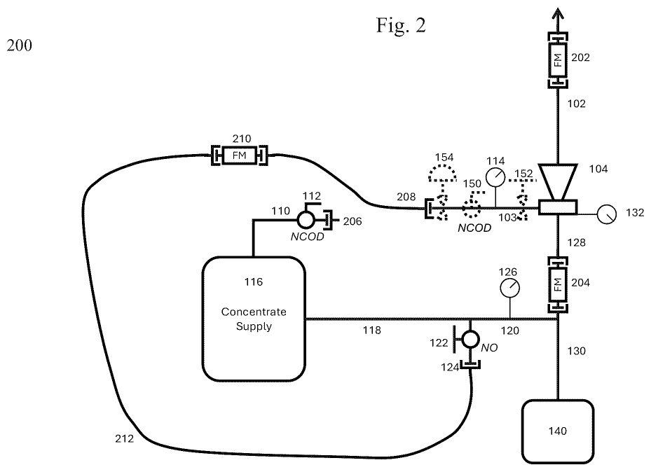

Transition piece 108 may be short as practical, but long enough to provide access for installation and removal of a hose or tubing 208 and the cap with vent 206 (See FIG. 2).

In still further exemplary embodiments, a primary liquid hose connection assembly comprised of a hose connection control valve 122 and hose connection 124 may be located anywhere along primary liquid pipes, for example at 118, 120, 128 or 130.

Referring to the exemplary embodiment in FIG. 2, FIG. 2 may illustrate a proportioning accuracy test system 200 that is in testing mode. According to one embodiment the system 200 may include the embodiments of FIG. 1 and system 100 with the removal of the transition piece 108 and the addition of one or more additional components. The additional components may be, but are not limited to, hose or tubing 208 & 212, a flow measurement device 210 to measure surrogate flow, a flow measurement device 202 to measure solution flow, a flow measurement device 204 to measure primary liquid flow, a cap with vent 206, a hose connection 124, a hose connection control valve 122 and/or a variety of valves and devices common to proportioning systems. Multiple valves, hoses, flow meters, and pressure gauges may be integrated into the system, depending on the applications.

It may be contemplated that configurations other than the configuration depicted in FIG. 2 may be utilized, as desired. In such an exemplary embodiment, however, the use of flow measurement device 202 or flow measurement device 204 may be dependent upon the configuration, accessibility, environmental concerns, business concerns, and other factors impacting the usefulness and practicality of placing a flow measurement device 202 anywhere in or on the solution discharge outlet 102. In practice, flow measurement device 202 may not be needed if flow measurement device 204 was utilized, and vice versa.

In still further exemplary embodiments, flow measurement device 202 and flow measurement device 204 may portable. They may also be permanently or semi-permanently installed and plumbed.

In still further exemplary embodiments, flow measurement device 210 and hose and tubing 208 & 212 may be portable. They may also be permanently or semi-permanently installed and plumbed.

In still further exemplary embodiments, the internal pipe volume between concentrate control valve 112 and cap with vent 206 may be minimized to facilitate post-testing clean up and decontamination.

In still further exemplary embodiments, additional valves or gauges may be provided in the hose and tubing 208 & 212 to allow accurate control of flow and pressure losses through the lines.

In still further exemplary embodiments, individual pressure gauges may be placed at pressure taps 114, 126 or 132, where pressure tap 132 may be integral to the first input of the proportioning device or may be located on a primary liquid pipe 128 or 130. Alternatively, a differential pressure measurement device may be placed between pressure taps 114 & 126 or 114 & 132.

In still further exemplary embodiments, the individual pressure gauges at the pressure taps 114, 126 or 132 and the alternative differential pressure measurement device between the pressure taps 114 & 126 or 114 & 132 may be portable. They may also be permanently or semi-permanently installed and plumbed.

According to some embodiments the transition piece of the testing system may be incorporated into the piping of the proportioning system between the concentrate source and the proportioning device while in others the transition piece may remain in place when the system is in non-testing mode and be removed when the system is in test mode. In some embodiments the transition piece may be shaped or configured to prevent concentrate residue or seepage from migrating to and contaminating the system piping and components downstream of it when the system is in non-testing mode.

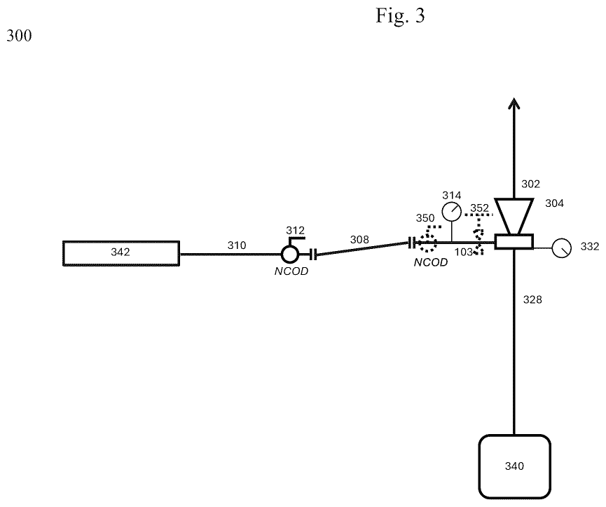

Referring to the exemplary embodiment in FIG. 3, FIG. 3 may illustrate a proportioning accuracy test system 300 that is in non-testing mode. The system 300 may include a variety of components. The components may be, but are not limited to, a transition piece 308, pressure taps 314 & 332, and a variety of valves and devices common to foam or other proportioning systems. Multiple valves, hoses, flow meters, and pressure gauges may be integrated into the system, depending on the application.

It may be understood that according to an embodiment the proportioning system 300 may include a proportioning device 304 which may incorporate a primary liquid from a pressurized source 340 and a pressurized or atmospheric concentrate from a pressurized or atmospheric concentrate tank or supply 342 in order to generate a solution. The solution may be understood to require a specific ratio or range of ratios according to the proportioning system specifications. The output of the proportioning device 304 may then connect to a solution discharge outlet 302 which may discharge the solution.

It may be contemplated that configurations other than the configuration depicted in FIG. 3 may be utilized, as desired. In such an exemplary embodiment, however, the placement of the pressure tap 314 may be relocated based upon accessibility, overall configuration of the proportioning system's plumbing, to enhance analysis accuracy, and/or for other purposes.

In still further exemplary embodiments, a secondary control valve 350 may be installed to prevent water intrusion into the transition piece 308 if the proportioning device 304 remains full and/or pressurized with primary fluid when the system is in non-testing mode. Further, the operation of secondary control valve 350 may be the same as the concentrate control valve 312 and may be addressed in the operating logic or instructions of the proportioning system. Additionally, a drain and/or vent valve may be provided on the transition piece 308 to allow it to be depressurized and drained in the event of leakage at the concentrate control valve 312 or the secondary control valve 350.

In still further exemplary embodiments, the outlet of the transition piece 308 may be at a higher elevation than its inlet to minimize the potential of concentrate residues or seepage at the concentrate control valve 312 entering and contaminating any system components downstream of the transition piece 308. Alternatively, the transition piece 308 may incorporate a sump, well, widening, contour or other variation in shape or configuration to create an area into which concentrate residues or seepage at the concentrate control valve 312 may collect or a raised area to prevent concentrate residues or seepage at the concentrate control valve 312 from traveling across the transition piece 308. Alternatively, the transition piece 308 may be replaced by a permanently piped valve configuration or other means to provide an air gap between the foam concentrate source and the proportioning device and prevent contamination of the surrogate liquid by the concentrate or concentrate residue when the system is in testing mode when the system is in testing mode in lieu of a removable transition piece 308.

In still further exemplary embodiments, transition piece 308 may be located as close to the concentrate control valve 312 as practical to minimize cleanup and decontamination in the event of concentrate residue transition or seepage at the concentrate control valve 312.

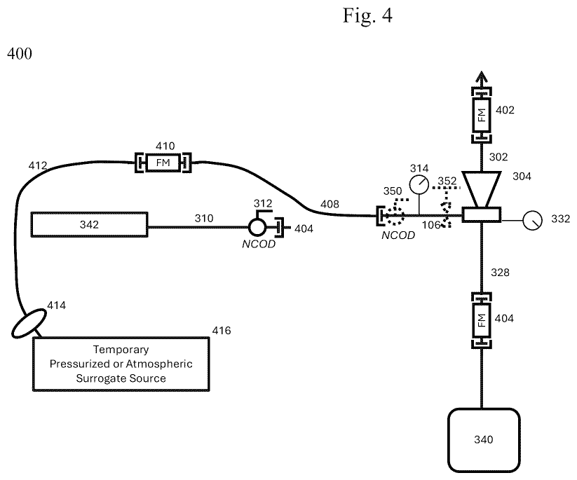

Transition piece 308 may be as short as practical, but long enough to provide access for installation and removal of hose or tubing 408 and the cap with vent 404 (See FIG. 4).

Referring to the exemplary embodiment in FIG. 4, FIG. 4 may illustrate a proportioning accuracy test system 400 that is in testing mode. The testing system 400 may include the embodiments of FIG. 3 and system 300 with the removal of transition piece 308 and the addition of a variety of components. The additional components may be, but are not limited to, hose or tubing 408 & 412, a flow measurement device 410 to measure surrogate flow, a flow measurement device 402 to measure solution flow, a flow measurement device 404 to measure primary liquid flow, a cap with vent 404, a surrogate flow rate and/or pressure control device or subsystem 414, a temporary pressurized or atmospheric surrogate source 416, and a variety of valves and devices common to proportioning systems. Multiple valves, hoses, flow meters, and pressure gauges may be integrated into the system, depending on the applications.

It may be contemplated that configurations other than the configuration depicted in FIG. 4 may be utilized, as desired. In such an exemplary embodiment, however, the use of flow measurement device 402 or flow measurement device 404 may be dependent upon the configuration, accessibility, environmental concerns, business concerns, and other factors impacting the usefulness and practicality of placing a flow measurement device 402 anywhere in or on the solution discharge outlet 302. In practice, flow measurement device 402 may not be needed if flow measurement device 404 was utilized, and vice versa.

In still further exemplary embodiments, flow measurement device 402 and flow measurement device 404 may be portable. They may also be permanently or semi-permanently installed and plumbed.

In still further exemplary embodiments, flow measurement device 410 and hose and tubing 408 & 412 may be portable. They may also be permanently or semi-permanently installed and plumbed.

In still further exemplary embodiments, surrogate flow rate and/or pressure control device or subsystem 414, and temporary pressurized or atmospheric surrogate source 416 may be portable. They may also be permanently or semi-permanently installed and plumbed.

In still further exemplary embodiments, the internal pipe volume between concentrate control valve 312 and cap with vent 404 may be minimized to facilitate post-testing clean up and contamination.

In still further exemplary embodiments, additional valves or gauges may be provided in hose and tubing 408 & 412 to allow accurate control of flow and pressure losses through the lines.

In still further exemplary embodiments, individual pressure gauges may be placed at pressure taps 314 and 332, where pressure taps 332 may be integral to the first input of the proportioning device or may be located on a primary liquid pipe 328. Alternatively, a differential pressure measurement device may be placed between pressure taps 314 and the flow and/or pressure control device, method, or means 332.

In still further exemplary embodiments, the individual pressure gauges at pressure taps 314 and 332 and the alternative differential pressure measurement device may be placed between pressure taps 314 and 332 may be permanently or semi-permanently installed and plumbed.

In still further exemplary embodiments, the flow and/or pressure control device or subsystem 414 may consist of any device, apparatus, assembly, or method to increase or decrease the pressure that the surrogate from the atmospheric or pressurized surrogate source 416 is delivered to the inlet of the hose or tubing 412. The pressure or vacuum conditions at the inlet of the hose or tubing 412 may be inherent or may be manipulated manually, automatically, or semi-automatically to support the test.

In still further exemplary embodiments, the flow and/or pressure control device or subsystem 414 may consist of any device, apparatus, assembly, or method to increase or decrease the flow rate at which the surrogate from the atmospheric or pressurized surrogate source 416 is delivered to the inlet of the hose or tubing 412. The flow rate of the surrogate at the inlet of the hose or tubing 412 may be inherent or may be manipulated manually, automatically, or semi-automatically to support the test.

Referring to the exemplary embodiment in FIG. 5, FIG. 5 may illustrate an alternative location for the placement of a transition piece, for example 508, where a single concentrate supply pipe 510 and primary liquid supply 528 may be connected to two or more proportioning devices 504 and multiple suppression systems, storage, processes, etc. 530.

It may be contemplated that configurations other than the configuration depicted in FIG. 5 may be utilized, as desired. In such an exemplary embodiment, one or more transition pieces 508 may be provided at an alternative location.

Installations that may have a single concentrate source such as 116 or 342 shown above may be connected to two or more proportioning devices 504 and utilizing an alternative location for one or more transition pieces 508 may include the embodiments of FIG. 1 and system 100, FIG. 2 and system 200, FIG. 3 and system 300, and FIG. 4 and system 400.

According to one or more embodiments the system may further be configured to permit the proportioning system to be safely actuated (manually, remotely, or automatically) with no foam concentrate or chemical discharge to prove the function and operation of all moving, electrical powered, engine driven, and hydraulic powered parts and components during the proportioning accuracy test.

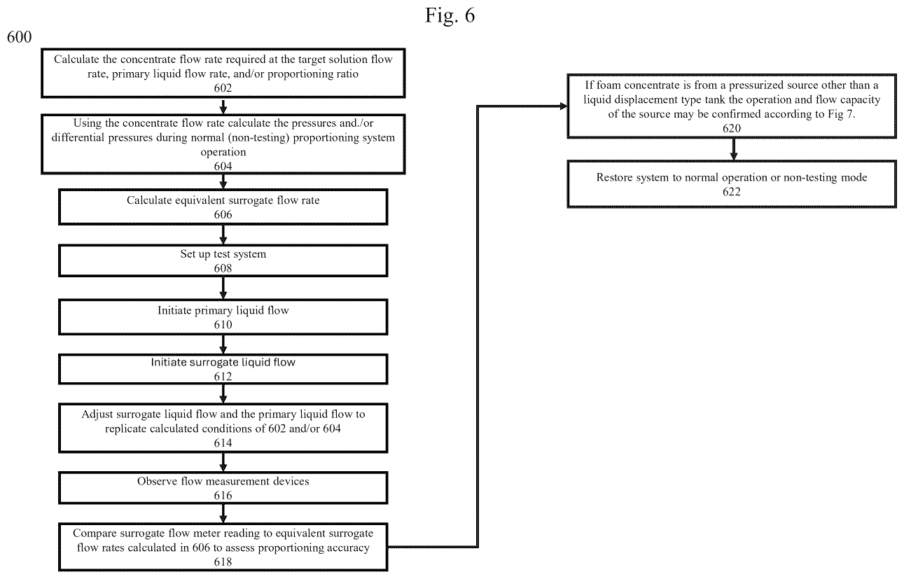

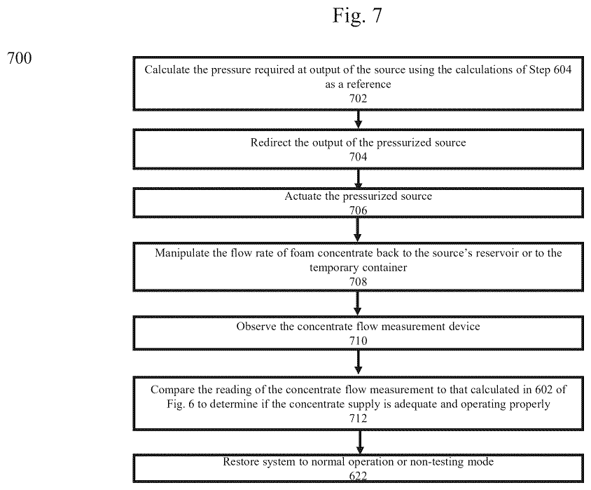

Referring to the exemplary embodiment in FIG. 6, FIG. 6 may illustrate a method of performing a proportioning accuracy test on a proportioning device, for example 104 shown in FIG. 1, of non-metered proportioning system. The method may be described with relation to the exemplary system described in FIG. 1, however it may be understood that the method may be applicable to a variety of proportioning devices or systems, including, for example, FIG. 3 above. In a first exemplary step 602 the purpose of the proportioning system may be assessed to identify applicable requirements and guidance on the solution flow rate and ratio of concentrate to primary fluid that is to be delivered at the solution discharge outlet 102. Further assessment may be carried out to identify the minimum and maximum ratios of concentrate to primary fluid that are acceptable and to determine a mean acceptable ratio of concentrate to primary fluid. This assessment may be repeated for each solution flow rate that the proportioning device may need to operate at. In the next exemplary step 604, hydraulic calculations may be completed using Newtonian and non-Newtonian criteria as appropriate to identify the pressure differential required across the concentrate supply or the inlets of the proportioning device 104 in order to deliver the mean concentrate flow to the proportioning device 104. Alternatively, hydraulic calculations may be completed to identify pressure requirements at specific points of the system, such as at the pressure taps 114, 126, 132, and/or 332. In the next exemplary step 606, calculations may be completed using Newtonian and non-Newtonian criteria as appropriate to identify surrogate flow rates that would be equivalent to the minimum, mean, maximum, or other concentrate flow rates. In exemplary step 608 the system may be set up in test mode and when all is ready primary liquid flow may be initiated in step 610 and then surrogate flow may be initiated in step 612. Once the primary liquid and surrogate flows have been initiated, in step 614 both may be manipulated until the solution or primary liquid flow rate of the first step and/or the pressures or pressure differentials of the second step have been satisfied. In the next step 616, the flow measurement devices 210, 202 and/or 204 may be recorded. In step 618, the reading of flow measurement device 210 may be compared against the minimum, mean, maximum or other equivalent surrogate flow rates established in step 606 to determine if the proportioning device 104 is able to accurately proportion concentrate into the primary liquid. In exemplary step 620 a pressurized source other than a liquid displacement type tank may be tested according to FIG. 7 to confirm operation and flow capacity adequacy. In the final step 622 the proportioning system may then be returned to non-testing mode.

Referring to FIG. 7, the process for testing the pressurized source of step 620 may be further described. In a first step 702 the pressure required at the outlet of the concentrate source may be calculated. In step 704 the outlet of the pressurized source may be redirected through a flow measurement device and to either the reservoir of the source or an independent container. In step 706 the pressurized source may be actuated. Once actuated, in step 708, the flow rate of the source to its reservoir or the temporary tank may be manipulated until the calculated pressure at the outlet of the source is achieved. The flow measurement device may then be observed in step 710. Finally in step 712 the observed flow measurement device may be compared to those required by the proportioning device 104 or devices as identified in 602 of FIG. 6 to determine if it proportioning device is operating accurately and properly.

The testing of the pressurized source illustrated in FIG. 7 may be performed independent of or simultaneously with the proportioning accuracy testing illustrated in FIG. 6

Further describing the testing process, according to some embodiments all calculations may be performed automatically, for example by a processor or other computing device with instructions to perform the one or more described calculations.

it may be understood that according to at least some embodiments hydraulic calculations may be completed prior to testing to establish pressure relationships within the concentrate piping and components between the concentrate reservoir and the concentrate inlet of the proportioning device.

In some further exemplary embodiments described herein, it may be envisioned that data obtained by the embodiments may be transmitted, in a wired or wireless fashion, and stored on an electronic device, such as a computer, tablet, smart phone, or other electronic device having a display, either located on or with the elements of the system or remotely. Further, it is envisioned that any element described herein could be controlled directly through mechanical actuation, electro-mechanical actuation, or via computer controls, either wired or wirelessly.

In some further exemplary embodiments described herein, it is envisioned that mass flow rates, liquid velocities, shear rates, or other engineering parameters utilized in the art and science of fluid dynamics may be utilized in lieu of volumetric flow rates.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for testing proportioning accuracy of a non-metered proportioning system, comprising:
a testing system comprising:
a primary liquid flow measurement device configured to measure a primary liquid flow and placed between a primary liquid pressurized source and a first input of a proportioning device or a liquid flow measurement device configured to measure solution flow through or from a solution discharge outlet;
a transition piece gap created by the removal of a transition piece or the transition piece configured to prevent concentrate flow through a concentrate pipe and to allow a surrogate liquid to be injected or drawn into a second input of the proportioning device without contamination from contact with the concentrate;
a plurality of pressure taps configured to monitor the hydraulic characteristics of the surrogate, primary liquid, and/or solution flow; and
a surrogate flow measurement device configured to measure a surrogate liquid flow and placed between a surrogate source and the second input of a proportioning device;
the testing system configured to operate with a proportioning system, wherein the proportioning system comprises the primary liquid pressurized source that provides a primary liquid, a concentrate source that supplies a concentrate, a solution discharge outlet, and a proportioning device configured to mix the primary liquid and the concentrate into a solution, the output of the proportioning device configured to deliver the solution to the solution discharge outlet, the primary liquid pipe located between the primary liquid pressurized source and the first input of the proportioning device configured to allow the primary liquid to flow to the proportioning device, the concentrate pipe located between the concentrate source and the second input of the proportioning device configured to allow the concentrate to flow to the proportioning device, and the transition piece located in the concentrate pipe between the proportioning device and the concentrate source; wherein the testing system is configured to determine the proportioning accuracy of the proportioning system based on comparing the primary liquid flow or solution flow and the surrogate liquid flow when running the surrogate liquid through the system against at least one pre-calculated equivalent surrogate flow rate.

2. The system of claim 1, wherein the concentrate is a non-Newtonian or Newtonian fluid and the surrogate liquid is a Newtonian fluid.

3. The system of claim 1, wherein the plurality of pressure taps include at least a pressure tap located on the concentrate pipe between the transition piece and the second input of the proportioning device and at least one additional pressure tap located on the primary liquid pipe or integrated into the first input of the proportioning device.

4. The system of claim 1, wherein the testing system is configured to utilize at least the transition piece of the proportioning system to create an air gap or physical separation so that the concentrate cannot flow from the concentrate source to the second input of the proportioning device and prevent contamination of the surrogate liquid by the concentrate or concentrate residue when the system is in testing mode when the system is in a test mode.

5. The system of claim 1, wherein the transition piece is configured to connect the concentrate source to the second input of a proportioning device when the system is not in the test mode.

6. The system of claim 5, wherein the transition piece is configured to collect or restrain the flow of concentrate residue or leakage from the concentrate control valve when the system is not in the test mode so that the residue or leakage does not enter the piping between the transition piece and the second input of the proportioning device.

7. The system of claim 1, wherein the testing system is portable, mobile, mounted on a vehicle, or temporary.

8. The system of claim 1, wherein the testing system is semi-permanently installed or permanently installed.

9. The system of claim 1, wherein the testing system is configured to be actuated remotely and/or automatically.

10. A method for testing proportioning accuracy of the non-metered proportioning system of claim 1 comprising;
removing the transition piece or configuring the transition piece to create an air gap or physical separation so that the concentrate or concentrate residue cannot flow from the concentrate source to the second input of a proportioning device or contaminate the surrogate liquid;
adding hose or tubing with a surrogate flow measurement device to connect a surrogate liquid source to the concentrate piping downstream of the transition piece, the surrogate flow measurement device configured to measure a surrogate flow rate;
capping off the piping upstream of the transition piece to prevent unintentional, accidental, and/or incidental release of the concentrate from the concentrate control valve;
adding a primary liquid flow measurement device in between the primary liquid source and the first input of the proportioning device, the primary liquid flow measurement device configured to measure a primary liquid flow rate or adding a flow measurement device in or on the solution discharge outlet configured to measure a solution flow rate, and the proportioning device configured to proportion the primary liquid supplied by the primary liquid source and the surrogate supplied by the surrogate source to form a solution;
initiating primary liquid flow through the first input of the proportioning device;
running the surrogate liquid through the hose or tubing with the surrogate flow measurement device;
manipulating the flow of the surrogate, the primary liquid, and/or the solution to replicate previously established flow and pressure relationships at the first input, the second input, and/or the solution discharge outlet of the proportioning device and/or at a plurality of specific points in the piping connected to the inputs and/or outlet;
determining a proportioning accuracy of the proportioning system by comparing the primary liquid flow rate or the solution flow rate and the surrogate liquid flow rate against the at least one pre-calculated equivalent surrogate flow rate.

11. The method of claim 10, further comprising completing one or more hydraulic calculations prior to determining the proportioning accuracy to establish at least a flow and pressure relationship at the first input, the second input and/or the solution discharge outlet of the proportioning device and/or at specific points in the piping connected to first input, the second input and/or the solution discharge outlet.

12. The method of claim 11, wherein the hydraulic calculations are based upon Newtonian and non-Newtonian fluid dynamics, the specific physical and hydraulic properties of the concentrate contained in the proportioning system's concentrate source, and the hydraulic characteristics of the foam concentrate pipe.

13. The method of claim 11, wherein the hydraulic calculations further include at least identifying a calculated surrogate flow rate equivalent to the concentrate flow rate at design basis flow rates and/or at each operational boundary of the proportioning system, the operational boundaries including at least a minimum flow rate and a maximum flow rate and/or other selected flow rates.

14. The method of claim 13, further comprising comparing the surrogate flow measurement device reading against at least the calculated equivalent surrogate flow rate.

15. The method of claim 10, wherein the proportioning accuracy test may be performed independent of, in conjunction with, or simultaneously with the flow and operational testing of a pressurized foam concentrate source.

16. A system for testing proportioning accuracy of a non-metered proportioning system, comprising:
a proportioning system comprising:
a primary liquid pressurized source that provides a primary liquid;
a concentrate supply that supplies a concentrate;
a solution discharge outlet; and
a proportioning device configured to mix the primary liquid and the concentrate into a solution, wherein the output of the proportioning device is configured to deliver the solution to the solution discharge outlet,
the primary liquid pipe is located between the primary liquid pressurized source and a first input of the proportioning device configured to allow the primary liquid to flow to the proportioning device
the concentrate pipe located between the concentrate source and a second input of the proportioning device configured to allow the concentrate to flow to the proportioning device; and
a transition piece located in the concentrate pipe between the concentrate source and the second input of the proportioning device;
a testing system comprising:
a primary liquid flow measurement device configured to measure the primary liquid flow and placed between the primary liquid pressurized source and the first input of a proportioning device or alternately a flow measurement device in or on the solution discharge outlet configured to measure solution flow; and
a surrogate flow measurement device configured to measure a surrogate liquid flow and placed between the surrogate source and the second input of a proportioning device;
wherein the testing system is configured to determine the proportioning accuracy of the proportioning system based on comparing the primary liquid flow or solution flow and the surrogate liquid flow when running a surrogate liquid through the system against at least one pre-calculated equivalent surrogate flow rate.
